(19) United States
(12) Patent Application Publication
(10) Pub. No.: US 2013/0326395 A1
(43) Pub. Date: Dec. 5, 2013

(54) METHOD OF UNLOCKING TOUCH SCREEN AND ELECTRONIC DEVICE USING THE SAME

(71) Applicants: Yoon Seok OH, Suwon (KR); Sang Hyun Sim, Suwon (KR); Bo Yle Seo, Suwon (KR); Ji Hoon Kim, Suwon (KR)

(72) Inventors: Yoon Seok OH, Suwon (KR); Sang Hyun Sim, Suwon (KR); Bo Yle Seo, Suwon (KR); Ji Hoon Kim, Suwon (KR)

(73) Assignee: SAMSUNG ELECTRO-MECHANICS CO., LTD., Suwon (KR)

(21) Appl. No.: 13/588,198

(22) Filed: Aug. 17, 2012

(30) Foreign Application Priority Data
May 31, 2012 (KR) 10-2012-0058071

(51) Int. Cl. G06F 3/048; G06F 3/041

(52) U.S. Cl. 715/781

(57) ABSTRACT

There are provided a method of unlocking a touch screen and an electronic device using the same. The electronic device includes: a display displaying a locked screen image in a screen locked state; a touch screen to which a touch is input; and a controlling unit unlocking the screen locked state when a first touch event continued for a first preset time or longer in the screen locked state and a second touch event generated within a second preset time after the first touch event has ended are sensed.

### CROSS-REFERENCE TO RELATED APPLICATIONS

This application claims the priority of Korean Patent Application No. 10-2012-0058071 filed on May 31, 2012, in the Korean Intellectual Property Office, the disclosure of which is incorporated herein by reference.

### BACKGROUND OF THE INVENTION

1. Field of the Invention

The present invention relates to a method of unlocking a touch screen and an electronic device using the same.

2. Description of the Related Art

A mobile communications terminal having multiple functions such as a camera, an MP3, a memo function, and the like, in addition to a voice call function, has recently become popular. Such a mobile communications terminal generally uses an information input scheme utilizing a touch screen, rather than an information input scheme using a plurality of buttons.

Generally, a mobile communications terminal including a touch screen includes a locking key provided on an outer surface thereof in order to prevent a accidental operations due to unintended touches by a user, thereby allowing the touch screen to be operated only in the case in which the user presses the locking key. However, in the case in which the locking key of the mobile communications terminal is unintentionally pressed, the mobile communications terminal may accidentally operate due to external inputs other than a user's input. Therefore, in order to prevent accidental operations, the touch screen is not immediately unlocked after the locking key of the mobile communications terminal is pressed, and a process of additionally unlocking the touch screen needs to be additionally provided.

Patent Document 1, the following Related Art Document, discloses an apparatus and a method in which a locked touch screen is displayed on a display and the touch screen is unlocked in the case in which a set operation is input to a slide bar displayed on the locked touch screen. The method disclosed in Patent Document 1 may additionally include unlocking the touch screen to prevent an accidental operation of a terminal including the touch screen due to an unintentional external input. However, even in this case, when a user moves while his or her mobile communications terminals is contained in his or her pocket, accidental operations may occur. Therefore, a method of unlocking a touch screen capable of more efficiently preventing an accidental operation has been required.

### RELATED ART DOCUMENT

(Patent Document 1) US Patent Laid-Open Publication No. US20070150842A1

### SUMMARY OF THE INVENTION

An aspect of the present invention provides a method of unlocking a touch screen capable of more efficiently preventing an accidental operation of the touch screen due to an unintentional input by introducing a time concept in unlocking the touch screen to control the touch screen to be unlocked when a first touch event continued for a first preset time or longer is input to a touch screen and a second touch event is input to the touch screen within a second preset time after the first touch event has ended, and an electronic device using the same.

According to an aspect of the present invention, there is provided an electronic device including: a display displaying a locked screen image in a screen locked state; a touch screen to which a touch is input; and a controlling unit unlocking the screen locked state when a first touch event continued for a first preset time or longer in the screen locked state and a second touch event generated within a second preset time after the first touch event has ended are sensed.

The first touch event may be a tap input, and the second touch event may be one of a tap input, a drag, and a flick.

The controlling unit may perform a control to generate vibrations or a sound in the electronic device when the first touch event is continued for the first preset time or longer.

The controlling unit may performs a control so that a preset event screen corresponding to each second touch event is displayed on display when the second touch event is one of a drag and a flick.

The controlling unit may perform a control so that a preset application corresponding to each second touch event is executed when the second touch event is one of a drag and a flick.

The locked screen image may include an unlockable region, and the controlling unit may unlock the screen locked state when the first touch event and the second touch event are generated in the unlockable region.

The unlockable region may include a first unlockable region and a second unlockable region, and the controlling unit may unlock the screen locked state when the first touch event is generated in the first unlockable region and the second touch event is generated in the second unlockable region.

The controlling unit may control the display so that the unlockable region is displayed in the locked screen image.

The controlling unit may control the display so that the first unlockable region and the second unlockable region are displayed in the locked screen image.

According to another aspect of the present invention, there is provided a method of unlocking a touch screen, the method including: displaying a locked screen image on a display in a screen locked state; sensing a touch event in the screen locked state; and unlocking the screen locked state when the touch event includes a first touch event continued for a first preset time or longer and a second touch event generated within a second preset time after the first touch event has ended.

The first touch event may be a tap input, and the second touch event may be one of a tap input, a drag, and a flick.

The method may further include generating vibrations or a sound in an electronic device including the touch screen when the first touch event is continued for the first preset time or longer.

The method may further include displaying a preset event screen corresponding to each second touch event on the display when the second touch event is one of a drag and a flick.

The method may further include executing a preset application corresponding to each second touch event when the second touch event is one of a drag and a flick.

The locked screen image may include an unlockable region, and in the unlocking of the screen locked state, the screen locked state may be unlocked when the first touch event and the second touch event are generated in the unlockable region.

The unlockable region may include a first unlockable region and a second unlockable region, and in the unlocking of the screen locked state, the screen locked state may be unlocked when the first touch event is generated in the first unlockable region and the second touch event is generated in the second unlockable region.

The method may further include displaying the unlockable region in the locked screen image.

The method may further include displaying the first unlockable region and the second unlockable region in the locked screen image.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a front view of an electronic device including a touch screen according to an embodiment of the present invention;

FIGS. 2 and 3 are views describing a process of unlocking a touch screen locked state by inputting a first touch event and a second touch event according to the embodiment of the present invention; and

FIG. 4 is a flow chart showing a method of unlocking a touch screen locked state according to the embodiment of the present invention.

### DETAILED DESCRIPTION OF THE INVENTION

Embodiments of the present invention will be described in detail with reference to the accompanying drawings. These embodiments will be described in detail for those skilled in the art in order to practice the present invention. It should be appreciated that various embodiments of the present invention are different but are not necessarily exclusive. For example, specific shapes, configurations, and characteristics described in an embodiment of the present invention may be implemented in another embodiment without departing from the spirit and the scope of the present invention. In addition, it should be understood that positions and arrangements of individual components in each disclosed embodiment may be changed without departing from the spirit and the scope of the present invention. Therefore, the detailed description provided below should not be construed as being restrictive. In addition, the scope of the present invention is defined only by the accompanying claims and their equivalents if appropriate. Similar reference numerals will be used to describe the same or similar functions throughout the accompanying drawings.

Hereinafter, exemplary embodiments of the present invention will be described in detail with reference to the accompanying drawings so that those skilled in the art may easily practice the present invention.

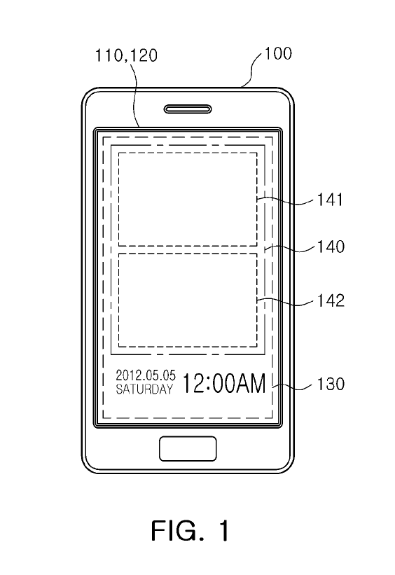

FIG. 1 is a front view of an electronic device including a touch screen according to an embodiment of the present invention.

Referring to FIG. 1, an electronic device 100 according to the embodiment of the present invention refers to all kinds of electronic devices including a touch screen. The electronic device 100 may include a display 110, a touch screen 120, and a controlling unit (not shown). The display 110 may display a locked screen image 130 in a state in which the touch screen is locked (hereinafter, referred to as a “screen locked state”), a touch may be input to the touch screen 120, and the controlling unit may control the display 110 and the touch screen 120. The touch screen 120 may be a capacitive touch screen or a resistive touch screen, but is not limited thereto.

When a first touch event continued for a first preset time or longer in the screen locked state and a second touch event generated within a second preset time after the first touch event has ended are sensed, the controlling unit may unlock the screen locked state. When the screen locked state is unlocked, the controlling unit may perform a control so that a screen image prior to the locked screen image or an idle screen image is displayed on the display 110.

When the first touch event is continued for the first preset time and the second touch event is generated within the second preset time after the first touch event has ended, the screen locked state may be unlocked. When the first touch event is continued for a time less than the first preset time or when the first touch event is continued for the first preset time or longer, but the second touch event is not input within the second preset time, the screen locked state may be maintained.

When the first touch event is continued for the first preset time or longer, the controlling unit may perform a control to generate vibrations or a sound in the electronic device, thereby informing a user that a first touch is validly input.

Referring to FIG. 1, the locked screen image 130 may include an unlockable region 140, wherein the unlockable region 140 may include a first unlockable region 141 and a second unlockable region 142. The unlockable region 140 indicates a region to which a touch for unlocking the touch screen in the locked state may be input. When a touch is input to a region other than the unlockable region 140, the controlling unit may control the touch screen 120 to maintain the screen locked state.

In addition, the controlling unit may control the display 110 so that the unlockable region 140 is displayed in the locked screen image 130. Although the unlockable 140 is represented by a dotted line in FIG. 1, it may be represented by a dotted line or a solid line and be non-transparently, semi-transparently, or transparently represented. In addition, although the unlockable region 140 is represented by a rectangular shape in FIG. 1, it may be represented by a circular or triangular shape and be represented by a shape set by a user.

The unlockable region 140 may include the first unlockable region 141 and the second unlockable region 142. The first unlockable region 141 refers to a region to which the first touch event for unlocking the touch screen in the locked state is input, and the second unlockable region 142 refers to a region to which the second touch event for unlocking the touch screen in the locked state is input.

Although FIG. 1 shows that the first unlockable region 141 and the second unlockable region 142 are positioned at different regions in the unlockable region 140, the present invention is not limited thereto. That is, the first unlockable region 141 and the second unlockable region 142 may be overlapped or coincide with each other. The controlling unit may control the display 110 so that the first unlockable region 141 and the second unlockable region 142 are displayed in the locked screen image 130. Although the unlockable region 140 is represented by a dotted line in FIG. 1, it may be represented by a dotted line or a solid line and be non-transparently, semi-transparently, or transparently represented. In addition, although the first unlockable region 141 and the second unlockable region 142 are represented by a rectangular shape, similar to the unlockable region 140, they may be represented by a circular or triangular shape, or may be represented by a shape set by the user.

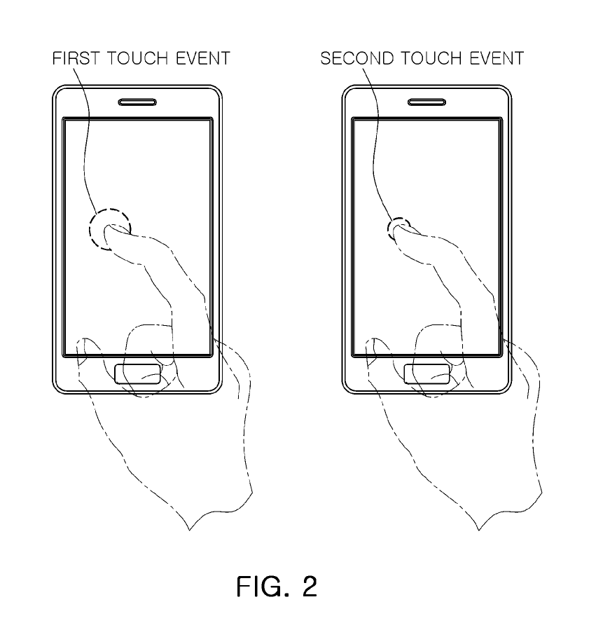

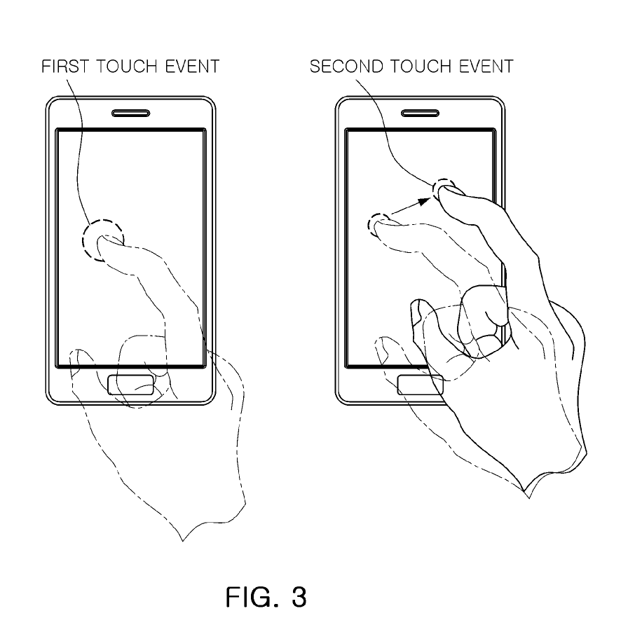

FIGS. 2 and 3 are views describing a process of unlocking a touch screen locked state by inputting a first touch event and a second touch event according to the embodiment of the present invention.

The first touch event input to the touch screen 120 may be a tap input, and the second touch event may be one of a tap input, a drag, and a flick. A tap input refers to an operation of slightly pressing and then releasing a single point of the touch screen once, a drag refers to an operation of moving from a single point of the touch screen to a specific position in a state in which the point on the touch screen is pressed, and an operation in which a finger is touched on a single point of the touch screen and moved in a direction by a certain distance, and then released therefrom, can be seen as an operation similar to a case in which a virtual page is turned on a touch screen.

Referring to FIG. 2, a finger of the user contacts a single point of the touch screen. In the left and right drawings of FIG. 2, a size of a circle including a portion at which a hand of the user contacts the touch screen means a time in which the hand of the user contacts the touch screen. More specifically, in the left drawing, the hand of the user is inputting the first touch event corresponding to the tap input to a single point of the touch screen, and in the right drawing, the hand of the user is inputting the second touch event corresponding to the tap input to a single point of the touch screen.

When the first touch event corresponding to the tap input is continued for the first preset time or longer and then ends and the controlling unit senses the input of the second touch event corresponding to the tap input within the second preset time after the first touch event has ended, the screen locked state may be unlocked. The first touch event needs to be continued for the first preset time or longer; however, the second touch event may be input regardless of continuation of the time. The first preset time may be set to be longer than that of a general tap input in order to prevent an accidental operation of the touch screen, but is not limited thereto. That is, the first preset time may be changed by setting by the user. Therefore, the preset time may be set to a short time such as the time required for the tap input.

Although FIG. 2 shows the first touch event and the second touch event performed by a single finger, the present invention is not limited thereto. That is, even though multiple touches are simultaneously input, it may be determined that the first touch event and the second touch event have been input. In addition, the touch is not limited to being performed by a finger, but may also be performed by the entire palm.

In the left and right drawings of FIG. 3, a size of a circle including a portion at which a hand of the user contacts the touch screen means a time in which the hand of the user contacts the touch screen. More specifically, in the left drawing, the hand of the user is inputting the first touch event corresponding to the tap input to a single point of the touch screen, while in the right drawing, the hand of the user is inputting the second touch event corresponding to one of the drag and the flick to a single point of the touch screen.

When the first touch event corresponding to the tap input is continued for the first preset time or longer and then ends and the controlling unit senses the input of the second touch event corresponding to one of the drag and the flick within the second preset time after the first touch event has ended, the screen locked state may be unlocked. When the screen locked state is unlocked, the controlling unit may perform a control so that a screen image prior to the locked screen image or an idle screen image is displayed on the display 110. Further, when the second touch event is one of the drag and the flick, the controlling unit may perform a control so that a preset event screen corresponding to each second touch event is displayed on the display 110 and perform a control so that a preset application corresponding to each second touch event is executed.

Although FIG. 3 shows the first touch event and the second touch event performed by a single finger of a user, similar to FIG. 2, the present invention is not limited thereto. That is, even though multiple touches are simultaneously input, it may be determined that the first touch event and the second touch event have been input. In addition, the touch is not limited to being performed by the finger, but may also be performed by the entire palm.

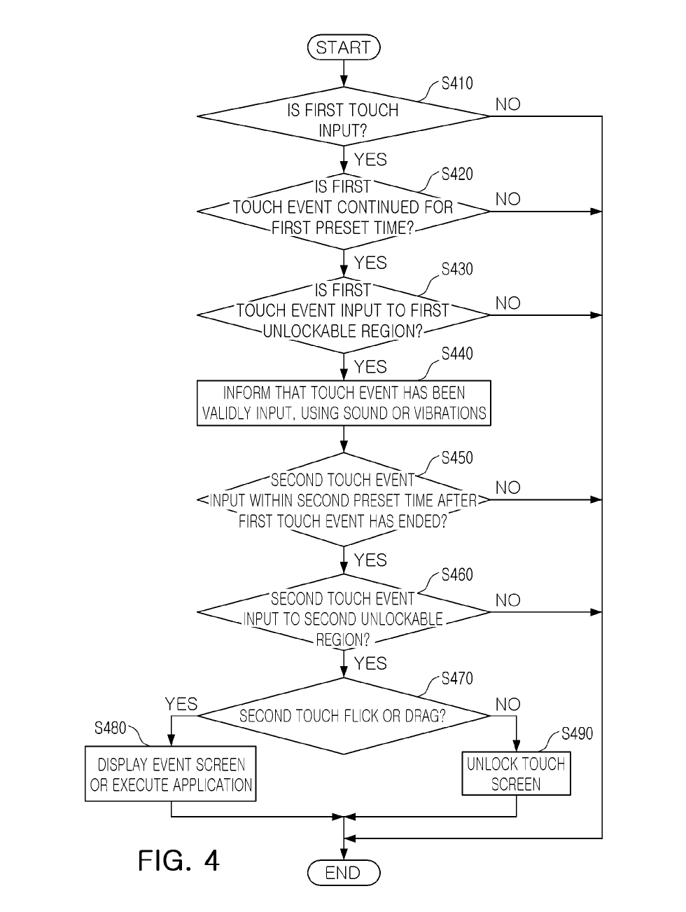

FIG. 4 is a flow chart showing a method of unlocking a touch screen locked state according to the embodiment of the present invention. Although FIG. 4 shows that steps S410 to S490 are sequentially performed, it is intended only to exemplarily describe the embodiment of the present invention. That is, since those skilled in the art to which the present invention pertains may make various modifications and alterations by allowing the electronic device 100 to perform steps S410 to S490 in a sequence changed from a sequence shown in FIG. 4 or perform one or more among steps S410 to S490 in parallel without departing from the essential characteristics of the present invention, steps S410 to S490 shown in FIG. 4 are not limited to a time-series sequence.

The electronic device 100 may display the locked screen image 130 on the display 110 in the state in which the screen is locked and sense that the touch event has been input to the touch screen 120.

More specifically, the electronic device 100 may determine whether the first touch event has been input (S410). In the case in which it is not determined that the first touch event has been input, the electronic device 100 may maintain the screen locked state, and in the case in which it is determined that the first touch event has been input, the electronic device 100 may determine whether or not the first touch event has been continued for the first preset time (S420). In the case in which the first touch event is not continued for the first preset time, the electronic device 100 may maintain the screen locked state, and in the case in which the first touch event is continued for the first preset time, the electronic device 100 may determine whether the first touch event has been input to the first unlockable region (S430). In the case in which the first touch event is not input to the first unlockable region, the electronic device 100 may maintain the screen locked state, and in the case in which the first touch event is input to the first unlockable region, the electronic device 100 may inform the user that the first touch event has been validly input, through using a sound or vibrations. In addition, in the case in which the user does not set the unlockable region, that is, the first unlockable region and the second unlockable region, when it is determined in step (S420) that the first touch event has been continued for the first preset time or longer, the electronic device 100 may inform the user that the first touch event has been validly input, through using a sound or vibrations (S440).

In the case in which the first touch event ends, the electronic device 100 may determine whether the second touch event has been input within the second preset time after the first touch event has ended (S450). In the case in which it is not determined that the second touch event has been input within the second preset time after the first touch event has ended, the electronic device 100 may maintain the screen locked state, and in the case in which it is determined that the second touch event has been input within the second preset time after the first touch event has ended, the electronic device 100 may determine that the second touch event has been input to the second unlockable region (S460). In the case in which it is not determined that the second touch event has been input to the second unlockable region, the electronic device 100 may maintain the screen locked state, and in the case in which it is determined that the second touch event has been input to the second unlockable region, the electronic device may determine whether the second touch event is one of the flick and the drag (S470). In the case in which the second touch event is the tap input which is not one of the flick and the drag, the electronic device 100 may unlock the screen and display a screen image prior to the locked screen image or an idle screen image (S490). In the case in which the second touch event is one of the drag and the flick, the electronic device 100 may display a preset event screen corresponding to each second touch event or execute a preset application corresponding to the second touch event (S480).

As set forth above, according to the embodiments of the present invention, a time concept is introduced in unlocking the touch screen to control the touch screen to be unlocked in the case in which the first touch event continued for the first preset time or longer is input to the touch screen and the second touch event is input to the touch screen within the second preset time after the first touch event has ended, whereby an accidental operation of the touch screen due to an unintentional input may be more efficiently prevented.

While the present invention has been shown and described in connection with the embodiments, it will be apparent to those skilled in the art that modifications and variations can be made without departing from the spirit and scope of the invention as defined by the appended claims.

What is claimed is:

1. An electronic device comprising:
a display displaying a locked screen image in a screen locked state;
a touch screen to which a touch is input; and
a controlling unit unlocking the screen locked state when a first touch event continued for a first preset time or longer in the screen locked state and a second touch event generated within a second preset time after the first touch event has ended are sensed.

2. The electronic device of claim 1, wherein the first touch event is a tap input, and
the second touch event is one of a tap input, a drag, and a flick.

3. The electronic device of claim 1, wherein the controlling unit performs a control to generate vibrations or a sound in the electronic device when the first touch event is continued for the first preset time or longer.

4. The electronic device of claim 1, wherein the controlling unit performs a control so that a preset event screen corresponding to each second touch event is displayed on display when the second touch event is one of a drag and a flick.

5. The electronic device of claim 1, wherein the controlling unit performs a control so that a preset application corresponding to each second touch event is executed when the second touch event is one of a drag and a flick.

6. The electronic device of claim 1, wherein the locked screen image includes an unlockable region, and
the controlling unit unlocks the screen locked state when the first touch event and the second touch event are generated in the unlockable region.

7. The electronic device of claim 6, wherein the unlockable region includes a first unlockable region and a second unlockable region, and
the controlling unit unlocks the screen locked state when the first touch event is generated in the first unlockable region and the second touch event is generated in the second unlockable region.

8. The electronic device of claim 6, wherein the controlling unit controls the display so that the unlockable region is displayed in the locked screen image.

9. The electronic device of claim 7, wherein the controlling unit controls the display so that the first unlockable region and the second unlockable region are displayed in the locked screen image.

10. A method of unlocking a touch screen, the method comprising:
displaying a locked screen image on a display in a screen locked state;
sensing a touch event in the screen locked state; and
unlocking the screen locked state when the touch event includes a first touch event continued for a first preset time or longer and a second touch event generated within a second preset time after the first touch event has ended.

11. The method of claim 10, wherein the first touch event is a tap input, and
the second touch event is one of a tap input, a drag, and a flick.

12. The method of claim 10, further comprising generating vibrations or a sound in an electronic device including the touch screen when the first touch event is continued for the first preset time or longer.

13. The method of claim 10, further comprising displaying a preset event screen corresponding to each second touch event on the display when the second touch event is one of a drag and a flick.

14. The method of claim 10, further comprising executing a preset application corresponding to each second touch event when the second touch event is one of a drag and a flick.

15. The method of claim 10, wherein the locked screen image includes an unlockable region, and
in the unlocking of the screen locked state, the screen locked state is unlocked when the first touch event and the second touch event are generated in the unlockable region.

16. The method of claim 15, wherein the unlockable region includes a first unlockable region and a second unlockable region, and
in the unlocking of the screen locked state, the screen locked state is unlocked when the first touch event is generated in the first unlockable region and the second touch event is generated in the second unlockable region.

17. The method of claim 15, further comprising displaying the unlockable region in the locked screen image.

18. The method of claim 16, further comprising displaying the first unlockable region and the second unlockable region in the locked screen image.
